(19) United States
(12) Patent Application Publication
(10) Pub. No.: US 2018/0191628 A1
(43) Pub. Date: Jul. 5, 2018

(54) SCHEDULING GRANULARITY BASED ON APPLICATION TYPE

(71) Applicants: Andrea Francini, Chapel Hill, NC (US); Charles R. Payette, Oceanport, NJ (US); Kamakshi Sridhar, Plano, TX (US); Jonathan Segel, Ottawa (CA); Edward Grinshpun, Freehold, NJ (US)

(72) Inventors: Andrea Francini, Chapel Hill, NC (US); Charles R. Payette, Oceanport, NJ (US); Kamakshi Sridhar, Plano, TX (US); Jonathan Segel, Ottawa (CA); Edward Grinshpun, Freehold, NJ (US)

(73) Assignees: Alcatel-Lucent USA Inc., Murray Hill, NJ (US); Alcatel-Lucent Canada Inc., Ottawa (CA)

(21) Appl. No.: 15/396,455

(22) Filed: Dec. 31, 2016

(51) Int. Cl. H04L 12/863; H04L 12/861; H04L 12/801; H04L 29/08; H04L 12/937

(52) U.S. Cl. CPC H04L 47/50; H04L 49/90; H04L 2012/5681; H04L 67/322; H04L 49/254; H04L 47/10

(57) ABSTRACT

The present disclosure generally discloses a scheduling granularity capability. The scheduling granularity capability is configured to improve scheduling granularity in a wireless communication system supporting transport of application flows via radio bearers. The scheduling granularity capability may be configured to support improved scheduling granularity by controlling scheduling at various levels of granularity, such as at the bearer level (e.g., for scheduling bearers with respect to each other), at the application flow level (e.g., for scheduling the application flow of a bearer when the bearer includes a single application flow, for scheduling application flows of a bearer with respect to each other when the bearer includes multiple application flows, or the like), or the like, as well as various combinations thereof. The scheduling granularity capability may be configured to support improved scheduling granularity by identifying application types of application flows supported by the bearers and controlling scheduling, at various layers of granularity, based on the application types of the application flows supported by the bearers.

### TECHNICAL FIELD

The present disclosure relates generally to communication systems and, more particularly but not exclusively, to improved scheduling granularity in wireless communication systems.

### BACKGROUND

In general, wireless communication systems support communication over an air interface between a wireless access device and wireless end devices which may communicate wirelessly with the wireless access device. Such wireless communication systems may include scheduling functions that schedule radio bearers for transmission of data units from the wireless access device to the wireless end devices over the air interface.

### SUMMARY

The present disclosure generally discloses a scheduling granularity capability that is configured to improve scheduling granularity in a wireless communication system.

In at least some embodiments, an apparatus includes a processor and a memory communicatively connected to the processor. The processor is configured to separate, for a bearer including a set of application flows, packets of the respective application flows into a respective set of per-flow queues associated with the respective application flows of the bearer. The processor is configured to identify, based on the per-flow queues associated with the respective application flows of the bearer, respective application types of the respective application flows of the bearer. The processor is configured to adapt scheduling of one of the application flows of the bearer based on one or more of the respective application types of one or more of the respective application flows of the bearer. The processor is configured to adapt scheduling of the bearer based on one or more of the respective application types of one or more of the respective application flows of the bearer. In at least some embodiments, a non-transitory computer-readable storage medium stores instructions which, when executed by a computer, causes the computer to perform a corresponding method. In at least some embodiments, a corresponding method is provided.

In at least some embodiments, an apparatus includes a processor and a memory communicatively connected to the processor. The processor is configured to identify, for a set of application flows of a set of bearers, respective application types of the respective application flows, wherein the set of bearers includes a first bearer supporting a first application flow and a second bearer supporting a second application flow and a third application flow. The processor is configured to adapt scheduling of one of the application flows based on one or more of the respective application types of one or more of the respective application flows of the set of bearers. The processor is configured to adapt scheduling of the set of bearers with respect to each other based on one or more of the respective application types of one or more of the respective application flows of the set of bearers. In at least some embodiments, a non-transitory computer-readable storage medium stores instructions which, when executed by a computer, causes the computer to perform a corresponding method. In at least some embodiments, a corresponding method is provided.

### BRIEF DESCRIPTION OF THE DRAWINGS

The teachings herein can be readily understood by considering the following detailed description in conjunction with the accompanying drawings, in which:

FIG. 1 depicts a communication system that is configured to support improved scheduling granularity in a wireless communication network;

FIG. 2 depicts a scheduler configured to support improved scheduling granularity in a wireless communication network;

FIG. 3 depicts an embodiment of a method configured to support improved scheduling granularity in a wireless communication network;

FIG. 4 depicts a wireless system including an embodiment of an LTE RAN configured to support improved scheduling granularity based on use of application-aware scheduling in the LTE RAN;

FIG. 5 depicts a wireless system including an embodiment of an LTE RAN configured to support improved scheduling granularity based on use of application-aware scheduling in the LTE RAN and based on a TCP proxy; and

FIG. 6 depicts a high-level block diagram of a computer suitable for use in performing various functions presented herein.

To facilitate understanding, identical reference numerals have been used, where possible, to designate identical elements that are common to the figures.

### DETAILED DESCRIPTION

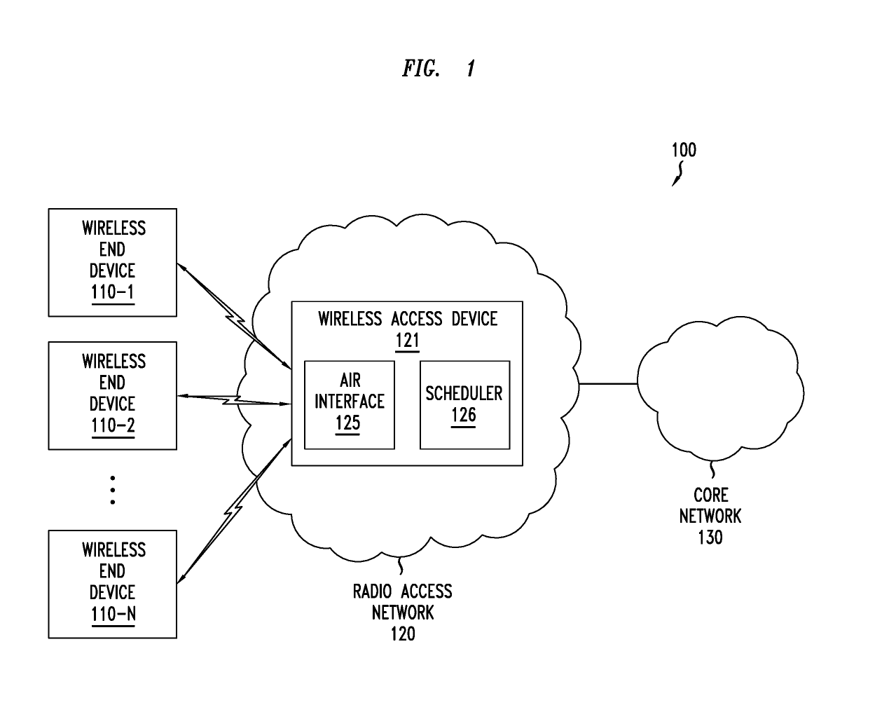

The present disclosure generally discloses a scheduling granularity capability. The scheduling granularity capability is configured to improve scheduling granularity in a wireless communication system supporting transport of application flows via radio bearers. The scheduling granularity capability may be configured to support improved scheduling granularity by controlling scheduling at various levels of granularity, such as at the bearer level (e.g., for scheduling bearers with respect to each other), at the application flow level (e.g., for scheduling the application flow of a bearer when the bearer includes a single application flow, for scheduling application flows of a bearer with respect to each other when the bearer includes multiple application flows, or the like), or the like, as well as various combinations thereof. The scheduling granularity capability may be configured to support improved scheduling granularity by identifying application types of application flows supported by the bearers and controlling scheduling, at various layers of granularity, based on the application types of the application flows supported by the bearers. The application types of the application flows supported by the bearers may be determined for bearers including single application flows and for bearers including multiple application flows. The application types of the application flows supported by the bearers may be determined based on cell-level status information (e.g., cell congestion information or the like), per wireless end device status information (e.g., the channel conditions of the wireless end devices or the like), per bearer status information (e.g., data unit arrival and queue occupancy statistics of bearer buffers which may be used for queuing the data units of the bearers or the like), per application flow status information associated with the individual application flows (e.g., packet arrival and queue occupancy statistics of flow-level queues which may be used for queuing the packets of the individual applications flows, or the like), or the like, as well as various combinations thereof. The per application flow status information for a bearer may be determined by separating packets of the bearer into per-flow queues (e.g., a single per-flow queue where the bearer includes a single application flow and multiple per-flow queues where the bearer includes multiple application flows) associated with the respective application flows (e.g., based on a tuple classification, such as a 5-tuple classification, a 6-tuple classification, or the like) and identifying the application types of the respective application flows (e.g., based on the respective sets of packets of the per-flow queues associated with the respective application flows and, optionally, based on other information). The scheduling granularity capability, for a set of bearers supporting a set of application flows, may be configured to support improved scheduling granularity by supporting scheduling of the bearers based on the application type information of the application flows and supporting scheduling of the application flows within the bearers that include multiple application flows based on the application type information of the application flows. It will be appreciated that these and various other embodiments and advantages of the scheduling granularity capability may be further understood by way of reference to the example communication system of FIG. 1.

FIG. 1 depicts a communication system that is configured to support improved scheduling granularity in a wireless communication network.

The communication system 100 includes a set of wireless end devices (WEDs) 110-1-110-N (collectively, WEDs 110), a radio access network (RAN) 120, and a core network (CN) 130.

The WEDs 110 are wireless end devices configured to communicate via the RAN 120. The WEDs 110 are configured to communicate with the RAN 120 based on wireless access to the RAN 120 using wireless resources of the RAN 120. The WEDs 110 may be connected with the RAN 120 using radio bearers (or, more simply, bearers), which, in general, are virtual links connecting the WEDs 110 with the RAN 120. The WEDs 110 each may be configured to communicate with the RAN 120 using one or more bearers, which may include one or more downlink (DL) bearers, one or more uplink (UL) bearers, or the like, as well as various combinations thereof. The WEDs 110 may be configured to use bearers to support transport of application flows of applications supported on the WEDs 110 (e.g., messaging applications, e-mail applications, web browsing applications, video applications, file transfer protocol applications, or the like).

The WEDs 110 may be configured to support communication of application flows of applications via bearers in various ways. In many types of WEDs 110, there is typically only one application running in the foreground at any given time and, thus, only a single application flow is included within each bearer; however, there may be various scenarios in which certain WEDs 110 may support multiple concurrent applications such that multiple application flows may be included within a single bearer. For example, many mobile device OS manufacturers are introducing multitasking, with split screens, which will allow multiple foreground applications to run concurrently such that multiple applications may share the same bearer. For example, proliferation of connected cars, where several mobile devices may share a single cellular connection, may result in a scenario in which multiple applications share the same bearer. It will be appreciated that there may be other scenarios in which multiple applications share the same bearer. As a result, the WEDs 110 may be configured to support communication of application flows of applications using one or more bearers in various ways (e.g., an application flow may be supported by its own dedicated bearer, multiple application flows may be supported using a single bearer, or the like, as well as combinations thereof).

The WEDs 110 may be wireless user devices (e.g., a smartphone, a tablet computer, a laptop computer, or the like), wireless machine-type-communication (MTC) devices, wireless Internet-of-Things (IoT) devices, or the like, as well as various combinations thereof.

The RAN 120 is configured to support wireless communications of the WEDs 110. The RAN 120 is configured to support wireless communications of the WEDs 110 using wireless resources of the RAN 120. The RAN 120 is configured to support communications of the WEDs 110 using radio bearers. The RAN 120 is configured to support transport of the application flows of the applications of the WEDs 110 using the radio bearers.

The RAN 120 includes a wireless access device (WAD) 121. The WAD 121 is configured to support wireless communications of the WEDs 110 using wireless resources of the RAN 120. The WAD 121 is configured to support communications of the WEDs 110 using radio bearers of the WEDs 110. The WAD 121 is configured to support transport of application flows of applications of the WEDs 110 using the radio bearers of the WEDs 110. This may include transport of downstream application flows to the WEDs 110 using DL bearers, transport of upstream application flows from the WEDs 110 using UL bearers, or the like, as well as various combinations thereof. The WAD 121 is configured to support scheduling for transport of application flows of applications of the WEDs 110 using the radio bearers of the WEDs 110. For example, the WAD 121 may be a 3G NodeB, an LTE evolved NodeB (eNodeB), a 5G remote radio head (RRH), or the like.

The WAD 121 includes an air interface 125. The air interface 125 is configured to support wireless resources which may be used for wireless communications of the WEDs 110. The wireless resources of the air interface 125 may be organized and controlled in various ways, which may depend on the underlying technology of the RAN 120. For example, in a 4G LTE RAN, the wireless resources of air interface 125 may be organized and controlled as physical resource blocks (PRBs). It will be appreciated that the wireless resources of air interface 125 may be organized and controlled in various other ways for other types of RANs. The bearers of the WEDs 110 may compete with each other for the wireless resources of the air interface 125 of the WAD 121.

The WAD 121 includes a scheduler 126. The scheduler 126 is configured to schedule use of the wireless resources of the air interface 125 by the WEDs 110.

The scheduler 126 may be configured to schedule use of the wireless resources of the air interface 125 by the WEDs 110 based on use of application-aware scheduling.

The scheduler 126 may be configured to schedule use of the wireless resources of the air interface 125 by the WEDs 110 based on use of application-aware scheduling by identifying application types of application flows of DL bearers of the WEDs 110 and performing one or more scheduling functions for the WEDs 110 based on the application types of the application flows of the DL bearers of the WEDs 110. It will be appreciated that the DL bearers for which the scheduler 126 performs scheduling may include one or more DL bearers supporting a single application flow, one or more DL bearers supporting multiple application flows, or combinations thereof.

The scheduler 126, as noted above, may be configured to identify the application types of the application flows of the DL bearers of the WEDs 110. The application types of application flows may include video, voice, data, or the like. The scheduler 126 may be configured to identify the application types of the application flows of the DL bearers of the WEDs 110 by queuing packets of the application flows of the DL bearers in respective per-flow queues associated with the application flows and identifying the application types of the application flows of the DL bearers. The scheduler 126 may be configured to identify the application types of the application flows of the DL bearers of the WEDs 110 based on various types of state information (e.g., cell-level status information (e.g., cell congestion information or the like), per-WED status information (e.g., the channel conditions of the WEDs 110, or the like), per bearer status information (e.g., data unit arrival and queue occupancy statistics of bearer buffers which may be used for queuing the data units of the DL bearers, or the like), per application flow status information associated with the individual application flows (e.g., packet arrival and queue occupancy statistics of flow-level queues which may be used for queuing the packets of the individual applications flows of DL bearers, or the like), or the like), as well as various combinations thereof.

The scheduler 126, as noted above, may be configured to perform one or more scheduling functions for the WEDs 110 based on application types of application flows of the DL bearers of the WEDs 110. The scheduler 126 may be configured to perform the scheduling functions for the WEDs 110, based on application types of application flows of the DL bearers of the WEDs 110, at various levels of granularity (e.g., at the bearer level for scheduling DL bearers with respect to each other, at the application flow level for scheduling an application flow of a DL bearer that supports a single application flow or for scheduling application flows of a DL bearer with respect to each other for a DL bearer that supports multiple application flows, or the like, as well as various combinations thereof).

The scheduling adaptation functions supported by the scheduler 126 may include adapting scheduling of one or more of the DL bearers of the WEDs 110 based on the respective application types of one or more of the application flows of one or more of the DL bearers of the WEDs 110.

The scheduling adaptation functions supported by the scheduler 126 may include adapting scheduling of one or more application flows of one or more of the DL bearers of the WEDs 110 based on the respective application types of one or more of the application flows of one or more of the DL bearers of the WEDs 110.

It is noted that the application type information that is identified may be used for adapting scheduling in various other ways, at various other levels of granularity, or the like, as well as various combinations thereof.

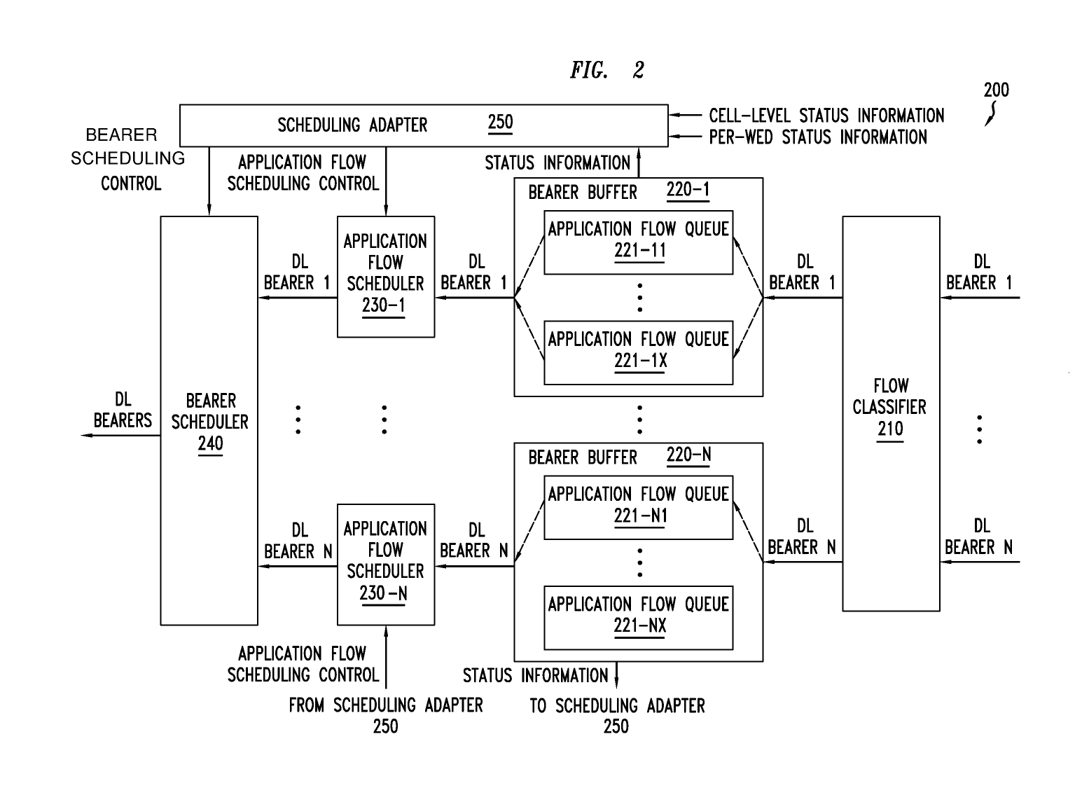

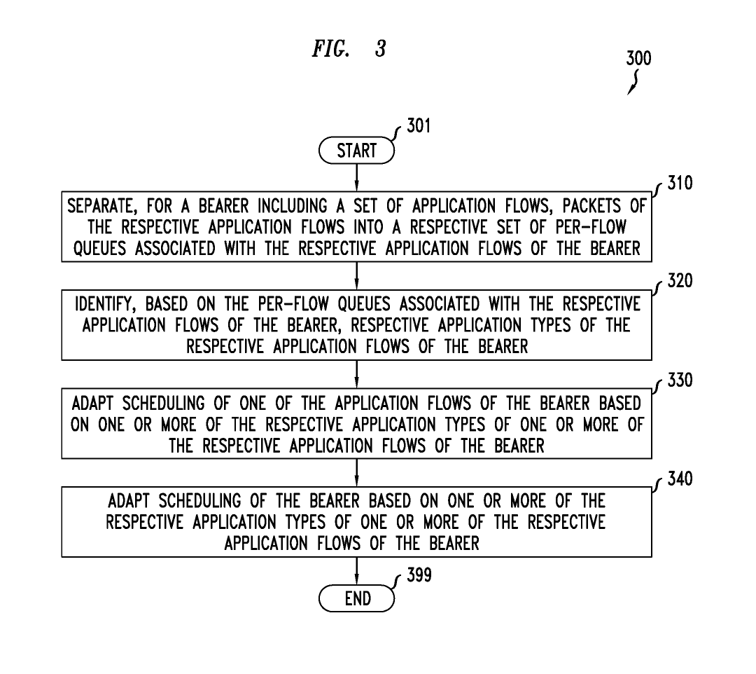

The scheduler 126 may be implemented in various ways. It will be appreciated that various functions of the scheduler 126 may be centralized (e.g., within a device, within an element of a device, or the like) or distributed (e.g., across devices, across elements of a device or devices, or the like). It will be appreciated that certain functions presented as being performed by the scheduler 126 may be performed by one or more elements that may be configured to cooperate with a scheduling entity to provide the various functions of scheduler 126 (e.g., identification of bearers including multiple application flows may be performed by an entity operating outside the scheduling entity, identification of the application types of the application flows may be performed by an entity operating outside the scheduling entity and the indications of the application types may then be communicated from the entity operating outside the scheduling entity to the scheduling entity for use in adapting scheduling of bearers and application flows, or the like). An example embodiment of the scheduler 126 (or functions of the scheduler 126) is presented with respect to FIG. 2. An example embodiment of a method for use by the scheduler 126 (or functions of the scheduler 126) is presented with respect to FIG. 3.

It will be appreciated that, although omitted for purposes of clarity, RAN 120 may include various other elements which may support communications of the WEDs 110 (e.g., routers, switches, gateways, controllers, or the like, as well as various combinations thereof).

The RAN 120 may be a Third Generation (3G) RAN (e.g., a Universal Mobile for Telecommunications (UMTS) RAN), a Fourth Generation (4G) RAN (e.g., a Long Term Evolution (LTE) RAN), a Fifth Generation (5G) RAN, or the like, as well as various combinations thereof.

The CN 130 is a core network configured to support communications of RAN 120. The CN 130 may include various network elements configured to support communications of RAN 120, where such network elements may vary for different types of wireless networks. For example, in the case of a 3G UMTS RAN, the CN 130 may include a Service GPRS Support Node (SGSN), a Gateway GPRS Support Node (GGSN), or the like. For example, in the case of a 4G LTE RAN, the CN 130 may include a Serving Gateway (SGW), a PDN Gateway (PGW), a Mobility Management Entity (MME), or the like. The CN 130 may provide access to one or more other packet data networks (PDNs) (e.g., a private data network such as an enterprise network, a public data network such as the Internet, or the like, as well as various combinations thereof).

FIG. 2 depicts a scheduler configured to support improved scheduling granularity in a wireless communication network.

The scheduler 200 is configured to support improved scheduling granularity for scheduling communications of a set of wireless end devices (which may include one or more wireless end devices which have been omitted from FIG. 2 for purposes of clarity). The scheduler 200 may be used as the scheduler 126 of the WAD 121 of FIG. 1.

The scheduler 200 is configured to support improved scheduling granularity for scheduling communications of one or more wireless end devices when the communications of the one or more wireless end devices are transported via a set of N DL bearers (denoted as DL bearer 1 through DL bearer N in FIG. 2, where it will be appreciated that N may be equal to or greater than one). The N DL bearers may be associated with a single wireless end device, less than N wireless end devices (e.g., one or more of the wireless end devices are using multiple DL bearers), or N wireless end devices (e.g., there is a single DL bearer for each of the N wireless end devices). The N DL bearers may include one or more DL bearers supporting multiple application flows (illustrated in FIG. 2 with respect to DL bearer 1, which is depicted as supporting X application flows where X>1), one or more DL bearers supporting single application flows (illustrated in FIG. 2 with respect to DL bearer N, which is depicted as supporting a single application flow), or the like, as well as various combinations thereof. It will be appreciated that, although primarily presented with respect to the case in which both types of DL bearers are supported (i.e., a combination of DL bearers supporting multiple application flows and DL bearers supporting single application flows), there may be situations in which each of the DL bearers supports multiple application flows and there may be situations in which each of the DL bearers supports a single application flow).

The scheduler 200 includes a flow classifier 210, a set of bearer buffers 220 (illustratively, bearer buffer 220-1 associated with the DL communication path of DL bearer 1 through bearer buffer 220-N associated with the DL communication path of DL bearer N) including respective sets of application flow queues 221 (illustratively, a set of application flow queues 221-1 associated with bearer buffer 220-1 through a set of application flow queues 221-N associated with bearer buffer 220-N), a set of application flow schedulers 230 (illustratively, application flow scheduler 230-1 associated with the DL communication path of DL bearer 1 through application flow scheduler 230-N associated with the DL communication path of DL bearer N), a bearer scheduler 240, and a scheduling adapter 250.

The flow classifier 210 is configured to receive the IP packets of each of the DL bearers. The flow classifier 210 is configured to classify the IP packets of the DL bearers for determining queuing of the IP packets of the DL bearers in application flow queues 221 of the bearer buffers 220 associated with the DL bearers. The flow classifier 210 is configured to, for each of the DL bearers, receive each incoming IP packet of the DL bearer, map a tuple of the IP packet header onto the identifier of a respective application flow queue 221-xy within the set of application flow queues 221-x of the bearer buffer 220-x of the DL bearer, and provide the IP packet to the application flow queue 221-xy identified by the mapping of the tuple of the IP packet header onto the identifier of the respective application flow queue 221-xy. For example, for DL bearer 1, flow classifier 210 is configured to receive every incoming IP packet of DL bearer 1, map a tuple of the IP packet header onto the identifier of a respective application flow queue 221-1y within the set of application flow queues 221-1 of bearer buffer 220-1, and provide the IP packet to the application flow queue 221-1y identified by the mapping of the tuple of the IP packet header onto the identifier of the respective application flow queue 221-1y. The tuple mapping that is used by the flow classifier 210 may be based on a 5-tuple, a 6-tuple, or the like. It will be appreciated that each of the bearer buffers 220 is depicted as including the same number of application flow queues (namely, X application flow queues 221 per bearer buffer) since each DL bearer may initially be associated with a certain number of application flow queues 221 (thereby obviating the need to determine the number of application flows per DL bearer in order to allocate queues for the application flows); however, the bearer buffers 220 may include different numbers of application flow queues 221 (e.g., where application flow queues are instantiated as application flows are activated).

The bearer buffers 220 provide storage resources for storing packets of the DL bearers. As discussed above, each of the bearer buffers 220 includes a set of application flow queues 221, respectively. For example, bearer buffer 220-1 includes X application flow queues denoted as application flow queues 221-11-221-1X (which may be referred to collectively as application flow queues 221-1). Similarly, for example, bearer buffer 220-N includes X application flow queues denoted as application flow queues 221-N1-221-NX (which may be referred to collectively as application flow queues 221-N). The bearer buffers 220-1-220-N are configured to buffer IP packets of the application flows of DL bearer 1 through DL bearer N, respectively, until the IP packets are to be provided to the bearer scheduler 240. The application flow queues 221 of the bearer buffers 220 are configured to receive the IP packets of the respective application flows of the respective DL bearers from the flow classifier 210 and to store the IP packets of the respective application flows of the respective DL bearers. The application flow queues 221 of the bearer buffers 220 are configured to release the IP packets of the respective application flows of the DL bearers from the bearer buffers 220 under the control of application flow schedulers 230. The application flow queues 221 of the bearer buffers 220 may be first-in first-out (FIFO) queues.

The bearer buffers 220 are configured to provide status information to the scheduling adapter 250 for use by the scheduler adapter 250 in identifying application types of the application flows of the DL bearers, such that the scheduling adapter 250 may control scheduling at various layers of granularity based on the application types of the application flows of the DL bearers. The status information may include status information related to queuing of the IP packets of the application flows of the DL bearers by the bearer buffers 220. The status information may include per bearer status information (e.g., data unit arrival and queue occupancy statistics at the DL bearer level, or the like), per application flow status information associated with the individual application flows (e.g., packet arrival and queue occupancy statistics of the application flow queues 221 that are used for queuing the IP packets of the individual applications flows, or the like), or the like, as well as various combinations thereof.

The application flow schedulers 230 are configured to support scheduling of application flows of the DL bearers. The application flow schedulers 230 may be configured to support scheduling of application flows of the DL bearers under the control of scheduling adapter 250 based on application types of application flows of the DL bearers supported by the scheduler 200. For example, the application flow scheduler 230 for a DL communication path of a DL bearer supporting multiple application flows (illustratively, the application flow scheduler 230-1 associated with the DL communication path of DL bearer 1) may support scheduling of the multiple application flows of the DL bearer with respect to each other (e.g., based on changing of scheduling weights associated with the application flow queues of the application flows) based on one or more application types of one or more of the multiple application flows of the DL bearer. For example, the application flow scheduler 230 for a DL communication path of a DL bearer supporting a single application flow (illustratively, the application flow scheduler 230-N associated with the DL communication path of DL bearer N) may support scheduling of the application flow of the DL bearer (e.g., based on changing of the scheduling weight associated with the application flow queue of the application flow) based the application type of the application flow of the DL bearer. It is noted that, in at least some embodiments, scheduling of one or more application flows of one or more DL bearers supported by the scheduler 200 may be based on one or more application types of one or more application flows of one or more DL bearers supported by the scheduler 200 (e.g., any application type information of any application flow may be used as a basis for scheduling any application flow).

The application flow schedulers 230 are configured to schedule the application flows of the DL bearers. The application flow schedulers 230 may schedule the application flows of the DL bearers using weighted round robin (WRR) scheduling or other suitable scheduling techniques. In the case of WRR, for example for a DL bearer including multiple application flows (e.g., DL bearer 1 associated with application flow scheduler 230-1), the scheduling weights applied to the application flow queues 221-1 of the bearer buffer 220-1 enable the application flow scheduler 230-1 to distribute the bandwidth of DL bearer 1 to the application flows of DL bearer 1. In the case of WRR, for example for a DL bearer including a single application flow (e.g., DL bearer N associated with application flow scheduler 230-N), the scheduling weights applied to the application flow queues 221-N of the bearer buffer 220-N may not change the frequency of selection of the application flow queues 221-N of the bearer buffer 220-N until one or more other application flows are supported by DL bearer N.

The application flow schedulers 230 may schedule the application flows of the DL bearers by controlling removal of IP packets of the application flows from the application flow queues 221 of the bearer buffers 220 and forwarding the IP packets of the application flows to the bearer scheduler 240. The application flow schedulers 230 are configured to receive application flow scheduling control information from the scheduling adapter 250 and to control scheduling of the application flows based on the application flow scheduling control information. The application flow scheduling control information from the scheduling adapter 250 may be based on application type information identifying the application types of the application flows of DL bearers. In the case of WRR scheduling or other weight-based scheduling techniques, the application flow scheduling control information may include scheduling weights determined based on application type information identifying the application types of the application flows of DL bearers. The application flow schedulers 230 provide IP packets of the application flows, based on the scheduling of the application flows, to the bearer scheduler 240 for scheduling transmission of the data units of the DL bearers over the air interface of the wireless access device in which the scheduler 200 is operating.

The bearer scheduler 240 is configured to support scheduling of DL bearers supported by the scheduler 200. The bearer scheduler 240 may be configured to support scheduling of DL bearers under the control of scheduling adapter 250 based on application types of application flows of DL bearers supported by the scheduler 200 (e.g., based on one or more application types of one or more application flows of one or more of the DL bearers).

The bearer scheduler 240 is configured to, during a current scheduling interval, schedule transmission of the N DL bearers over the air interface of the wireless access device in which the scheduler 200 is operating. The bearer scheduler 240 receives IP packets of the N DL bearers and schedules transmission of data units of the N DL bearers over the air interface. The bearer scheduler 240 receives bearer scheduling control information from the scheduling adapter 250 and schedules transmission of data units of the N DL bearers over the air interface based on the bearer scheduling control information. The bearer scheduling control information may be determined by the scheduling adapter 250 based on application type information indicative of application types of applications being transported by the N bearers (which, as indicated above, may be based on various types of status information received by scheduling adapter 250). The bearer scheduler 250 may schedule transmission of data units of the N DL bearers over the air interface by assigning physical resources of the air interface to the DL bearers. It will be appreciated that the DL bearers for which bearer scheduling is performed during a given scheduling interval may include all of the N DL bearers (as primarily discussed above) or a subset of the N DL bearers (e.g., selected based on application type information or other suitable information).

The scheduling adapter 250 is configured to control scheduling granularity for scheduler 200. The scheduling adapter 250 may be configured to cooperate with bearer buffers 220 and application flow schedulers 230 to control, based on application types of application flows of DL bearers supported by the scheduler 200, scheduling of application flows within DL bearers supported by the scheduler 200. The scheduling adapter 250 may be configured to cooperate with bearer buffers 220 and bearer scheduler 240 to control, based on application types of application flows of DL bearers supported by the scheduler 200, scheduling of the DL bearers supported by the scheduler 200.

The scheduling adapter 250 is configured to control scheduling associated with the DL bearers, which may include controlling scheduling of the DL bearers with respect to each other and controlling scheduling of application flows of DL bearers. The scheduling adapter 250 is configured to control scheduling associated with the DL bearers based on application type information indicative of the application types of the application flows supported by the DL bearers. The scheduling adapter 250 is configured to determine the application types of the application flows supported by the DL bearers, determine scheduling control information based on the application types of the application flows supported by the DL bearers, and control scheduling associated with the DL bearers based on the scheduling control information.

The scheduling adapter 250 is configured to determine the application types of the application flows supported by the DL bearers. The scheduling adapter 250 may be configured to determine the application types of the application flows supported by the DL bearers based on various types of status information. The status information may include cell-level status information which may be received by the scheduling adapter 250 (e.g., cell congestion level or the like), per wireless end device status information which may be received by the scheduling adapter 250 (e.g., information indicative of respective channel conditions experienced by the wireless end devices of the DL bearers), bearer-level status information which may be received by the scheduling adapter 250 from the bearer buffers 220 associated with the DL bearers (e.g., data unit arrival and queue occupancy statistics at the DL bearer level), application-level status information which may be received by the scheduling adapter 250 from bearer buffers 220 associated with DL bearers or from the application flow queues 221 of bearer buffers 220 associated with DL bearers (e.g., packet arrival and queue occupancy statistics of application flow queues 221 which may be used for queuing the packets of the individual applications flows of the DL bearers), or the like, as well as various combinations thereof. In at least some embodiments, scheduling adapter 250 may be configured to determine the application type information of the application flows that are supported by DL bearers, based on the status information, as described in U.S. patent application Ser. No. 14/610,598, which is hereby incorporated by reference herein.

The scheduling adapter 250 is configured to determine scheduling control information based on the application types of the application flows supported by the DL bearers and to control scheduling associated with the DL bearers based on the scheduling control information.

The scheduling adapter 250 is configured to control scheduling of application flows of DL bearers. The scheduling of the application flows of DL bearers may be based on application flow type information. The application flow type information may include one or more application flow types of one or more of the application flows of one or more of the DL bearers. The scheduling adapter 250 may determine, based on the application flow type information, application flow scheduling control information configured to control scheduling of application flows of DL bearers. The scheduling adapter 250 may provide the application flow scheduling control information to application flow schedulers 230 supporting the DL bearers for use by the application flow schedulers 230 in serving the application flow queues 221 of the bearer buffers 220 supporting the DL bearers. The application flow scheduling control information may depend on the type of application flow scheduling used by application flow schedulers 230 (e.g., scheduling weights where application flow schedulers 230 use a WRR scheduling technique). The application flow schedulers 230, as discussed above, are configured to control scheduling of the application flows of the DL bearers based on application flow scheduling control information received from scheduling adapter 250.

The scheduling adapter 250 is configured to control scheduling of the DL bearers. The scheduling of the DL bearers may be based on application flow type information. The application flow type information may include one or more application flow types of one or more of the application flows of the DL bearers. The scheduling adapter 250 may determine, based on the application flow type information, bearer scheduling control information configured to control scheduling of the DL bearers. The scheduling adapter 250 may provide the bearer scheduling control information to bearer scheduler 240. The bearer scheduler 240, as discussed above, is configured to control scheduling of the DL bearers (including assignment of physical resources on the air interface) based on bearer scheduling control information received from scheduling adapter 250.

It will be appreciated that, although primarily presented with respect to a specific implementation of the scheduler 200 (e.g., specific numbers, types, and arrangement of elements), other implementations of scheduler 200 (and, thus, also of scheduler 126) are contemplated.

FIG. 3 depicts an embodiment of a method configured to support improved scheduling granularity in a wireless communication network. It will be appreciated that, although primarily presented as being performed serially in FIG. 3, at least a portion of the functions of method 300 of FIG. 3 may be performed contemporaneously or in a different order than as presented in FIG. 3.

At block 301, method 300 begins.

At block 310, for a bearer including a set of application flows, packets of the respective application flows are separated into a respective set of per-flow queues associated with the respective application flows of the bearer. This also may be referred to as queuing packets of the respective application flows of the bearer in respective per-flow queues associated with the respective application flows of the bearer.

At block 320, respective application types of the respective application flows of the bearer are identified based on the per-flow queues associated with the respective application flows of the bearer.

At block 330, scheduling of one or more of the application flows of the bearer is adapted based on one or more of the respective application types of one or more of the respective application flows of the bearer.

At block 340, scheduling of the bearer is adapted based on one or more of the respective application types of one or more of the respective application flows of the bearer.

At block 399, method 300 ends.

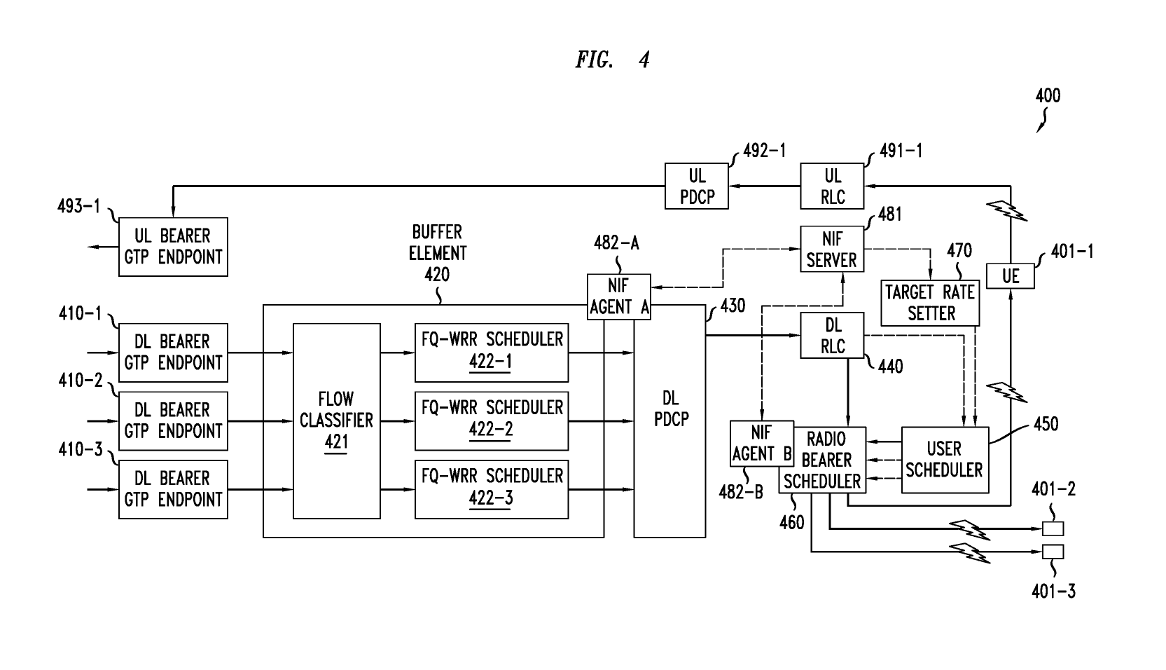

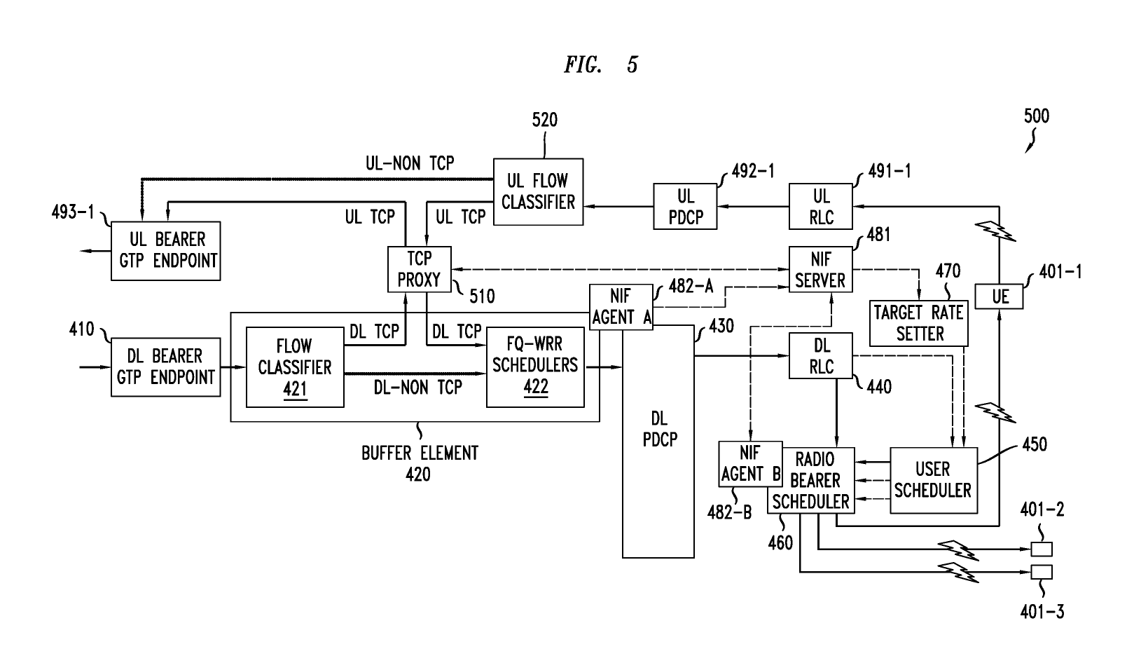

It will be appreciated that, as discussed above, improved scheduling granularity based on use of application-aware scheduling may be provided within various different types of RANs. Example embodiments for providing improved scheduling granularity within LTE RANs are presented with respect to FIGS. 4-5.

FIG. 4 depicts a wireless system including an embodiment of an LTE RAN configured to support improved scheduling granularity based on use of application-aware scheduling in the LTE RAN.

The wireless system 400 includes three instances of user equipment (UE) 401-1-401-3 (collectively, UEs 401) and a portion of an LTE RAN. It will be appreciated that the UEs 401 may be a particular case of the WEDs 110 of FIG. 1. It will be appreciated that fewer or more UEs 401 may be supported by the LTE RAN. The DL communication path and UL communication path are depicted for UE 401-1 since the DL communication path for UE 401-1 includes multiple application flows. The DL communication paths for UEs 401-2 and 401-3 are depicted but the UL communication paths for UEs 401-2 and 401-3 are omitted for purposes of clarity, since the DL communication paths for UEs 401-2 and 401-3 each include only a single application flow.

The LTE RAN supports DL communication paths for the UEs 401, and includes elements operating within the DL communication paths for the UEs 401. The LTE RAN includes a set of DL bearer General Packet Radio Service (GPRS) Tunneling Protocol (GTP) endpoints 410-1-410-3 (collectively, DL bearer GTP endpoints 410), a buffering element (BE) 420, a DL Packet Data Convergence Protocol (PDCP) element 430, a DL Radio Link Control (RLC) element 440, a user scheduler (US) 450, a radio bearer scheduler (RBS) 460, a Target Rate Setter (TRS) 470, and a scheduling control function (primarily referred to herein as a Network Insights Function (NIF), but which also may be referred to more generally as a scheduling adaptation function, scheduling functions, control function, or the like). The BE 420 includes a flow classifier 421 and a set of flow queues with weighted round robin schedulers (FQ-WRR-schedulers) 422-1-422-3 (collectively, FQ-WRR-schedulers 422). The NIF, as discussed further below, may be composed of various elements, including an NIF server 481 and a set of distributed NIF Agents 482 which may communicate with the NIF server 481. The set of distributed NIF Agents 482 includes an NIF Agent A 482-A that is associated with the DL communication paths of the UEs 401 an NIF Agent B 482-B that is associated with the RBS 460. The NIF server 481 and the NIF Agents 482 may be configured to provide various application-aware scheduling functions.

The DL communication path for UE 401-1 includes the DL bearer GTP endpoint 410-1, the BE 420, the DL PDCP element 430, the DL RLC element 440, and the RBS 460. The DL bearer GTP endpoint 410-1 is configured to yield native Internet Protocol (IP) packets that are mapped to the DL bearer for UE 410-1. The DL flow classifier 421 is configured to receive the IP packets from the DL bearer GTP endpoint 410-1, classify the IP packets for separation of the IP packets into application flows supported by the DL bearer, and provide the IP packets of the application flows to respective flow queues of the FQ-WRR-scheduler 422-1. The DL flow classifier 421 may classify the IP packets and separate the IP packets into application flows supported by the DL bearer based on tuple mapping. The tuple mapping may be based on application of a hash function to tuples of the IP headers of the IP packets (e.g., the 5-tuple, the 6-tuple, or the like). The FQ-WRR-scheduler 422-1 is configured to receive the IP packets of the application flows from the DL flow classifier 421 and store packets of the respective application flows within the respective flow queues of the application flows. The FQ-WRR-scheduler 422-1 supports a weighted round robin scheduler (although it will be appreciated that other scheduling schemes may be used). The weighted round robin scheduler of the FQ-WRR-scheduler 422-1 is configured to serve the application flows of the DL bearer of the UE 401-1. The weighted round robin scheduler of the FQ-WRR-scheduler 422-1 may be configured to assign scheduling weights to the flow queues, under the control of the NIF server 481 via the NIF Agent A 482-A associated with FQ-WRR-scheduler 422-1, for controlling scheduling of the application flows of the DL bearer based on the application types of the application flows supported by the DL bearer. The scheduling weights enable the weighted round robin scheduler of the FQ-WRR-scheduler 422-1 to distribute the bandwidth of the DL bearer to the application flows of the DL bearer (again, based on the application types of the application flows supported by the DL bearer since the scheduling weights are determined based on such application type information). The FQ-WRR-scheduler 422-1 is configured to provide the IP packets of the flow queues serving the application flows of the DL bearer to the DL PDCP element 430. The DL PDCP element 430 is configured to receive the IP packets of the flow queues serving the application flows of the DL bearer from the FQ-WRR-scheduler 422-1 and convert them into PDCP data units. The DL PDCP element 430 is configured to provide the PDCP data units of the application flows of the DL bearer to the DL RLC element 440. The DL RLC element 440 is configured to receive the PDCP data units of the DL bearer from the DL PDCP element 430 and convert them into RLC data units. The DL RLC element 440 may be configured to use a buffer for storage of RLC data units. The DL RLC element 440 is configured to provide information about the DL bearer of the UE 401-1 to the US 450 (e.g., for use in determining scheduling of the RLC data units for transmission over the air interface) and to provide the RLC data units of the DL bearer of the UE 401-1 to the RBS 460 (e.g., for scheduling of the RLC data units for transmission over the air interface).

The DL communication path for UE 401-2 is similar to the DL communication path for UE 401-1. The DL communication path for UE 401-2 includes the DL bearer GTP endpoint 410-2, the BE 420, the DL PDCP element 430, the DL RLC element 440, and the RBS 460. The DL bearer GTP endpoint 410-2 is configured to yield native IP packets that are mapped to the DL bearer for UE 410-2. The DL flow classifier 421 is configured to receive the IP packets from the DL bearer GTP endpoint 410-2, classify the IP packets of the application flow supported by the DL bearer, and provide the IP packets of the application flow to a flow queue of the FQ-WRR-scheduler 422-2. The FQ-WRR-scheduler 422-2 of BE 420 is configured to provide the IP packets of the application flow of the DL bearer to the DL PDCP element 430. The DL PDCP element 430 is configured to receive the IP packets of the application flow of the DL bearer from FQ-WRR-scheduler 422-2 of BE 420 and to convert them into PDCP data units. The DL PDCP element 430 is configured to provide the PDCP data units of the DL bearer to the DL RLC element 440. The DL RLC element 440 is configured to receive the PDCP data units of the DL bearer from the DL PDCP element 430 and convert them into RLC data units. The DL RLC element 440 may be configured to use a buffer for storage of the RLC data units. The DL RLC element 440 is configured to provide information about the DL bearer of the UE 401-2 and about the application flow of the DL bearer of the UE 401-2 to the US 450 (e.g., for use in determining scheduling of the RLC data units for transmission over the air interface) and to provide the RLC data units of the DL bearer of the UE 401-2 to the RBS 460 (e.g., for scheduling of the RLC data units for transmission over the air interface).

The DL communication path for UE 401-3 is similar to the DL communication path for UE 401-1. The DL communication path for UE 401-3 includes the DL bearer GTP endpoint 410-3, the BE 420, the DL PDCP element 430, the DL RLC element 440, and the RBS 460. The DL bearer GTP endpoint 410-3 is configured to yield native IP packets that are mapped to the DL bearer for UE 410-3. The DL flow classifier 421 is configured to receive the IP packets from the DL bearer GTP endpoint 410-3, classify the IP packets of the application flow supported by the DL bearer, and provide the IP packets of the application flow to a flow queue of the FQ-WRR-scheduler 422-3. The FQ-WRR-scheduler 422-3 of BE 420 is configured to provide the IP packets of the application flow of the DL bearer to the DL PDCP element 430. The DL PDCP element 430 is configured to receive the IP packets of the application flow of the DL bearer from FQ-WRR-scheduler 422-3 of BE 420 and convert them into PDCP data units. The DL PDCP element 430 is configured to provide the PDCP data units of the DL bearer to the DL RLC element 440. The DL RLC element 440 is configured to receive the PDCP data units of the DL bearer from the DL PDCP element 430 and convert them into RLC data units. The DL RLC element 440 may be configured to use a packet buffer for storage of the RLC data units. The DL RLC element 440 is configured to provide information about the DL bearer of the UE 401-3 and about the application flow of the DL bearer of the UE 401-3 to the US 450 (e.g., for use in determining scheduling of the IP packets for transmission over the air interface) and to provide the RLC data units of the DL bearer of the UE 401-3 to the RBS 460 (e.g., for scheduling of the RLC data units for transmission over the air interface).

The US 450 is configured to, during a current scheduling interval, select which of the DL bearers are to be considered by the RBS 460 for scheduling on the air interface in a next scheduling interval. The US 450 is configured to select which of the DL bearers are to be considered by the RBS 460 for scheduling on the air interface in a next scheduling interval based on DL bearer information associated with the DL bearers. The DL bearer information associated with the DL bearers may include information describing the DL bearers (e.g., received by US 450 from DL RLC element 440), target rate information associated with the DL bearers (e.g., received by US 450 from TRS 470), or the like, as well as various combinations thereof. The target rate information may be based on application types of the application flows supported by the DL bearers. This is illustrated by the path from the NIF server 481 to the TRS 470, where the target rate information may be determined by the NIF server 481 based on application type information determined by the NIF server 481 and provided to the TRS 470, determined by the TRS 470 based on application type information received from the NIF server 481, or the like, as well as various combinations thereof. The US 450 is configured to provide an indication of the selected DL bearers to the RBS 460 for use by the RBS 460 for scheduling on the air interface in a next scheduling interval.

The RBS 460 is configured to, during a current scheduling interval, schedule transmission of data units of DL bearers over the air interface. The RBS 460, as discussed above, receives data units of the various DL bearers supported by the LTE RAN (illustratively, the DL bearers of UEs 401-1, 401-2, and 401-3, respectively). The RBS 460 also receives DL bearer selection information from the US 450 which, as noted above, includes indications of the selected DL bearers selected by the US 450 for scheduling by the RBS 460 on the air interface in a current scheduling interval. The RBS 460 also receives, from the NIF server 481 via the NIF Agent B 482-B associated with the RBS 460, application type information indicative of application types of application flows transported by the DL bearers. The RBS 460 is configured to schedule transmission of data units of DL bearers over the air interface based on the DL bearer selection information from the US 450 (e.g., only scheduling the selected DL bearers selected by the US 450) and based on the application type information (e.g., determining the scheduling of the selected DL bearers based on the application type information). The RBS 460 may schedule transmission of data units of DL bearers over the air interface by assigning physical resources of the air interface to the selected DL bearers selected by the US 450. The RBS 460 may assign physical resources of the air interface to the selected DL bearers based on the application type information.

The TRS 470 is configured to determine target rate information for the DL bearers of the UEs 401 (e.g., target rates for the DL bearers of the UEs 401 or the like) and to provide the target rate information for the DL bearers to the US 450 for use in selecting the selected DL bearers for which the RBS 460 performs scheduling to schedule transmission of data units of the DL bearers of the UEs 401 over the air interface. The TRS 470 may receive the target rate information from the NIF server 481 (e.g., determined by the NIF server 481 based on application type information identifying application types of the application flows of the DL bearers), determine the target rate information based on application type information received from the NIF server 481, or the like, as well as various combinations thereof.

The NIF server 481 is configured to provide various functions of a scheduler that is configured to support application-aware scheduling (e.g., functions of scheduler 200 of FIG. 2, functions of scheduler 126 of FIG. 1, or the like).

The NIF server 481 is configured to, for each of the DL bearers of the UEs 401, determine application type information of the application flows that are supported by the DL bearers of the UEs 401 and control scheduling of the application flows and the DL bearers of the UEs 401 based on the application type information. In the case in which multiple application flows are supported by a DL bearer (e.g., as with the DL bearer of UE 401-1), the application type information includes respective application types of the multiple applications flows supported by the DL bearer. In the case in which a single application flow is supported by a DL bearer (e.g., as with the DL bearers of UE 401-2 and UE 401-3), the application type information includes the application type of the application supported by the DL bearer.

The NIF server 481 is configured to determine the application type information of the application flows that are supported by the DL bearers of the UEs 401 based on various types of information, which may include per-UE information, cell-level information, or the like, as well as various combinations thereof. The per-UE information may include per DL bearer status information (e.g., data unit arrival and queue occupancy statistics of bearer buffers which may be used for queuing the data units of the DL bearers), per application flow status information associated with the individual application flows (e.g., packet arrival and queue occupancy statistics of flow-level queues which may be used for queuing the packets of the individual applications flows of bearers supporting multiple application flows, or the like), information indicative of respective channel conditions experienced by the UEs 401, or the like, as well as various combinations thereof. The NIF server 481 may receive the per-UE information from the NIF Agent A 482-A, from the NIF Agent B 482-B, or the like, as well as various combinations thereof. The cell-level information may include information associated with the cell with which the UEs 401 are associated (e.g., cell congestion level or the like). The NIF server 481 may receive the cell-level information from the NIF Agent B 482-B. The NIF server 481 may be configured to determine the application type information of the application flows that are supported by the DL bearers of the UEs 401 based on various other types of information.

The NIF Agents 482 are configured to collect information from various parts of the LTE RAN and to provide the collected information to the NIF server 481 for analysis in determining application types of application flows supported by the DL bearers of the UEs 401.

The information that is collected and provided by NIF Agent A 482-A may include per DL bearer status information for each of the DL bearers (e.g., data unit arrival and queue occupancy statistics of bearer-level queues which may be used for queuing the data units of the DL bearers, such as FQ-WRR-scheduler 422-1 for the DL bearer of UE 401-1, the FQ-WRR-scheduler 422-2 for the DL bearer of UE 401-2, and the FQ-WRR-scheduler 422-3 for the DL bearer of UE 401-3), per application flow status information associated with the individual application flows (e.g., packet arrival and queue occupancy statistics of flow-level queues, such as flow-level queues of the FQ-WRR-scheduler 422-1 for the DL bearer of UE 401-1, flow-level queues of the FQ-WRR-scheduler 422-2 for the DL bearer of UE 401-2, and flow-level queues of the FQ-WRR-scheduler 422-3 for the DL bearer of UE 401-3), or the like, as well as various combinations thereof. The per DL bearer status information may include, for a given DL bearer, the pattern of data unit arrivals to the buffer of the DL bearer, the pattern of evolution of the queue occupancy at the buffer of the DL bearer, or the like, as well as various combinations thereof. The per application flow status information may include, for a given application flow of a given DL bearer, the pattern of packet arrivals to the flow queue of the application flow of the DL bearer, the pattern of evolution of the queue occupancy at the flow queue of the application flow of the DL bearer, or the like, as well as various combinations thereof. The information that is collected and provided by NIF Agent A 482-A may include other types of information which may be used by the NIF server 481 to determine application type information.

The information that is collected and provided by NIF Agent B 482-B may include the patterns of service opportunities offered by the RBS 460 to the DL bearers (based on association with RBS 460). The information that is collected and provided by NIF Agent B 482-B may include the channel condition information indicative of channel conditions experienced by the individual UEs 401. The information that is collected and provided by NIF Agent B 482-B may include cell congestion level information indicative of the cell congestion level of the cell in which the UEs 401 are operating (which may be calculated by the NIF Agent B 482-B based on the channel condition information). The information that is collected and provided by NIF Agent B 482-B may include other types of information which may be used by the NIF server 481 to determine application type information.

The NIF Agents 482 may be configured to collect various other types of information from various other parts of the LTE RAN and to provide the collected information to the NIF server 481 for analysis in determining application types of application flows supported by the DL bearers of the UEs 401.

The NIF server 481, as indicated above, is configured to determine the application type information of the application flows that are supported by DL bearers of the UEs 401 based on various types of information (e.g., per-UE information, cell-level information, or the like, as well as various combinations thereof). In at least some embodiments, NIF server 481 may be configured to determine the application type information of the application flows that are supported by DL bearers of the UEs 401, based on the received information, as described in U.S. patent application Ser. No. 14/610,598, which is hereby incorporated by reference herein. In at least some embodiments, for example, the reference metric for application type identification may be the number of per-flow IP bytes that arrive at the queue manager per binning time interval.

The NIF server 481 is configured to control scheduling within the LTE RAN for the UEs 401 based on the application type information of the application flows that are supported by DL bearers of the UEs 401.

The NIF server 481 is configured to control scheduling of the application flows within the DL bearers of the UEs 401 based on the application type information. The NIF server 481 is configured to control scheduling of the application flows within the DL bearers of the UEs 401 based on the application type information by determining scheduling weights for the flow queues of the FQ-WRR-schedulers 422 of the BE 420 based on the application type information of the respective application flows associated with the respective flow queues and providing indications of the scheduling weights to the FQ-WRR-schedulers 422 of the BE 420. The NIF server 481 may provide indications of the scheduling weights to the FQ-WRR-schedulers 422 of the BE 420 by sending the indications of the scheduling weights to the NIF Agent A 482-A associated with BE 420. It will be appreciated that the scheduling weights for the flow queues may be indicative of the service rates for the flow queues.

The NIF server 481 is configured to control scheduling of the DL bearers of the UEs 401 based on the application type information. The NIF server 481 may determine scheduling control information based on the application type information and provide the scheduling control information to one or more elements of the LTE RAN for controlling scheduling of the DL bearers of the UEs 401 of the LTE RAN. For example, as discussed further below, NIF server 481 may provide scheduling control information to one or more of TRS 470 (e.g., for controlling scheduling performed by US 450), RBS 460 (e.g., for controlling scheduling performed by RBS 460), or the like, as well as various combinations thereof.

The NIF server 481 may be configured to control scheduling of the DL bearers of the UEs 401, based on the application type information, by determining scheduling control information based on the application type information and providing the scheduling control information to the TRS 470. The scheduling control information provided to the TRS 470 may include information which may be used by TRS 470 to determine the target rates for the DL bearers. The scheduling control information provided to the TRS 470 may include target rates suggested by the NIF server 481 for one or more of the DL bearers (which the TRS 470 may use as the target rates for the DL bearers, which the TRS 470 may analyze to determine the target rates for the DL bearers, or the like). The scheduling control information provided to the TRS 470 may include indications of any DL bearers that may require special treatment (e.g., for consideration by the TRS 470 in determining the target rates for the DL bearers). The TRS 470, as indicated above, may be configured to provide the target rates for the DL bearers to the US 450 for use by the US 450 in controlling scheduling of the DL bearers over the air interface. The NIF server 481 may be configured to control the scheduling of the DL bearers of the UEs 401, based on interaction with the TRS 470, in various other ways.

The NIF server 481 may be configured to control scheduling of the DL bearers of the UEs 401, based on the application type information, by determining scheduling control information based on the application type information and providing the scheduling control information to the RBS 460 for use by the RBS 460 in scheduling the DL bearers for transmission via the air interface. The scheduling control information provided to the RBS 460 may include information for use by the RBS 460 in determining which of the DL bearers are to be serviced during a given scheduling interval. The scheduling control information provided to the RBS 460 may include information for use by the RBS 460 in determining quantities of air interface resources to be provided to DL bearers during a given scheduling interval. The scheduling control information provided to the RBS 460 may include information for use by the RBS 460 in assigning resources of the air interface to DL bearers during a given scheduling interval. The scheduling control information provided to the RBS 460 may include information for use by the RBS 460 in assigning DL data units of the DL bearers to physical resources of the air interface during a given scheduling interval. The scheduling control information provided to the RBS 460 may include various other types of information for use by the RBS 460 in scheduling the DL bearers for transmission of data units via the air interface. The NIF server 481 may be configured to provide the scheduling control information to the RBS 460 by providing the scheduling control information to the NIF Agent B 482-B which, in turn, may provide the scheduling control information to the RBS 460. The NIF server 481 may be configured to control the scheduling of the DL bearers of the UEs 401, based on interaction with the NIF Agent B 482-B, in various other ways.

The NIF server 481, in this manner, can utilize a combination of the application flow scheduling weights in the FQ-WRR-schedulers 422 of the BE 420 (configured through NIF agent A 482-A) and the DL bearer scheduling rate in the US 450 (configured through the TRS 470) to support an ideal service rate for the DL flows of the UEs 401 of LTE RAN.

The operation of the LTE RAN in supporting improved scheduling granularity for the UEs 401 may be further understood by way of an example. For this example, assume that the LTE RAN has been configured to optimize the handling of Hypertext Transfer Protocol (HTTP) Adaptive Streaming (HAS) video streams. For this example, also assume that one of the application flows of the DL bearer of the UE 401-1 is a HAS video stream, that the other application flows of the DL bearer of the UE 401-1 are non-video flows (e.g., a voice flow and a file transfer flow), that the application flow of the DL bearer of UE 401-2 is a non-video flow (e.g., a file transfer flow), and that the application flow of the DL bearer of the UE 401-3 is a non-video flow (e.g., a file transfer flow). For the HAS video flow within the DL bearer of UE 401-1, for each DL packet of the HAS video flow that is received, the DL packet arrives at the DL bearer GTP endpoint 410-1 where the tunneling header is stripped, the DL packet goes through the DL flow classifier 421 for hashing of its IP header onto a flow queue ID that is common to all packets of the same flow, and the DL packet reaches the flow queue of the corresponding flow queue ID in the FQ-WRR-scheduler 422-1. The NIF Agent A 482-A associated with the DL bearer for UE 401-1 reports to the NIF server 481 on the packet arrival and queue occupancy statistics of the individual flow queues of the FQ-WRR-scheduler 422-1 on a per-flow basis. This enables the NIF server 481 to analyze data for individual application flows (versus bearer-level data from the DL bearer serving multiple application flows), thereby resulting in a higher rate of success in identifying the HAS video flow from among the application flows supported by the DL bearer of the UE 401-1. The NIF Agent A 482-A associated with the DL bearers for UEs 401-2 and 401-3, respectively, also report to the NIF server 481 on the packet arrival and queue occupancy statistics of bearer-level queues which may be used for queuing the DL data units of the DL bearers of the UEs 401-2 and 401-3, respectively. The NIF Agent B 482-B associated with the RBS 460 reports to the NIF server 481 on the channel conditions experienced by the individual UEs 401 and on the overall cell congestion level of the cell in which the UEs 401 are operating. The NIF server 481 analyzes the data from the NIF Agents 482 and, based on the analysis, identifies the HAS video flow being transported by the DL bearer of the UE 401-1. The NIF server 481, based on identification of the HAS video flow transported by the DL bearer of the UE 401-1, may control scheduling of the HAS video flow (and, thus, the other application flows) as follows: (1) the NIF server 481 informs the TRS 470 that the HAS video flow requires special treatment (e.g., the NIF server 481 may suggest a target rate for the HAS video flow or the TRS 470 may determine the target rate for the HAS video flow autonomously) and (2) the NIF server 481 informs the weighted round robin scheduler of the FQ-WRR-scheduler 422-1 as to which of the application flows supported by the FQ-WRR-scheduler 422-1 is the HAS video flow such that the weighted round robin scheduler of the FQ-WRR-scheduler 422-1 can appropriately adjust the scheduling weight for the HAS video flow. The expected joint effect of the two adjustments is an improvement of the quality-of-experience (QoE) for the video user, by elimination of re-buffering events and stabilization of the delivered video quality.

The LTE RAN also supports UL communication paths for the UEs 401, and includes elements operating within the UL communication paths for the UEs 401 (although for purposes of clarity, only the UL communication path of UE 401-1 is depicted in FIG. 4). The UL communication path for UE 401-1 includes a UL RLC element 491-1, a UL PDCP element 492-1, and a UL bearer GTP endpoint 493-1. The UL communication paths of UEs 401-2 and 401-3 are similarly arranged.

It will be appreciated that the LTE RAN may be configured to provide various other functions to support granular scheduling within the LTE RAN.

It will be appreciated that, although primarily presented with respect to a specific implementation of the LTE RAN (e.g., specific numbers, types, and arrangement of elements), various other implementations of LTE RAN are contemplated. It will be appreciated that the LTE RAN may be configured in various other ways to support improved scheduling granularity (e.g., using one or more of different arrangements of the elements, additional elements, or the like, as well as various combinations thereof).

FIG. 5 depicts a wireless system including an embodiment of an LTE RAN configured to support improved scheduling granularity based on use of application-aware scheduling in the LTE RAN and a TCP proxy.

The wireless system 500 builds upon the wireless system 400. The wireless system 500 depicts each of the elements of the wireless system 400, and also includes additional elements configured to support a TCP proxy capability. The additional elements include a TCP proxy 510 and a UL flow classifier 520. The TCP proxy 510 and UL flow classifier 520 are associated with the DL communication path of UE 401-1, since per application flow scheduling granularity is being provided for the DL communication path of UE 401-1. It is noted that similar TCP proxies and UL flow classifiers may be instantiated for other UEs (e.g., UEs 401-2 and 401-3) where per application flow scheduling granularity is being applied for the DL bearers of such other UEs.

The TCP proxy 510 is configured to split TCP connections transporting application flows of the DL bearer of UE 401-1. For the DL communication path, the TCP proxy 510 is disposed between the DL flow classifier 421 and the FQ-WRR-scheduler 422-1. The DL flow classifier 421 provides non-TCP-based application flows (e.g., those based on UDP or other transport layer protocols other than TCP) to the FQ-WRR-scheduler 422-1 directly (bypassing the TCP proxy 510) as in wireless system 400 of FIG. 4. The DL flow classifier 421 provides TCP-based application flows to the TCP proxy 510, which in turn provides the TCP-based application flows to the FQ-WRR-scheduler 422-1. As a result, the FQ-WRR-scheduler 422-1 receives each of the application flows of the DL bearer of the UE 401-1, as in wireless system 400 of FIG. 4.

The TCP proxy 510 is configured to split TCP connections transporting application flows of the UL bearer of UE 401-1. For the UL communication path, the UL flow classifier 520 is configured to classify packets of the UL communication path in order to identify, from the traffic on the UL communication path, TCP ACKs associated with TCP-based application flows on the DL communication path. For the UL communication path, the TCP proxy 510 is disposed between the UL flow classifier 520 and the UL bearer GTP endpoint 493-1. The UL flow classifier 520 provides TCP ACKs associated with TCP-based application flows on the DL communication path to the TCP proxy 510, which in turn provides the TCP ACKs associated with TCP-based application flows on the DL communication path to the UL bearer GTP endpoint 493-1. The UL flow classifier 520 provides other traffic on the UL communication path (i.e., other than the TCP ACKs associated with TCP-based application flows on the DL communication path) to the UL bearer GTP endpoint 493-1 directly. As a result, the UL bearer GTP endpoint 493-1 receives each of the UL flows of the UL bearer of the UE 401-1, as in wireless system 400 of FIG. 4.

The TCP proxy 510 enables TRS 470 to control not only the target rate of each DL bearer, but also the time distribution of services given to each DL bearer. This time distribution of services given to a DL bearer may include the introduction of extra delays based on a determination that introduction of such extra delays increases the overall utilization of the radio resources of the LTE RAN. Without TCP proxy 510, compressing or delaying the delivery of the data over the final wireless link could adversely impact the normal operation of the TCP source of the content origin. The TCP proxy 510 may be used to hide the scheduling gaps introduced by the US 450 from the TCP source of the content origin, thereby preventing the artificial scheduling gaps from interfering abnormally with the state of the TCP source of the content origin. If properly informed by the NIF server 481 of ongoing modifications of the ordinary scheduling pattern, the side of the TCP proxy 510 that faces the UE 401-1 can compensate for the modifications without letting them affect the state, and, therefore, the performance, of the TCP source of the content origin. It is noted that, since the DL flow classifier 421 not only maps IP packets onto respective flow queues, but also separates TCP traffic (which is subject to the TCP proxy 510) from UDP traffic (which bypasses the TCP proxy 510), the UL flow classifier 520 is also needed in the uplink direction for directing, to the TCP proxy 510, the TCP acknowledgments that return from the UE 401-1.

It will be appreciated that the TCP proxy 510 may be configured to provide various other functions to support improved scheduling granularity within the LTE RAN.

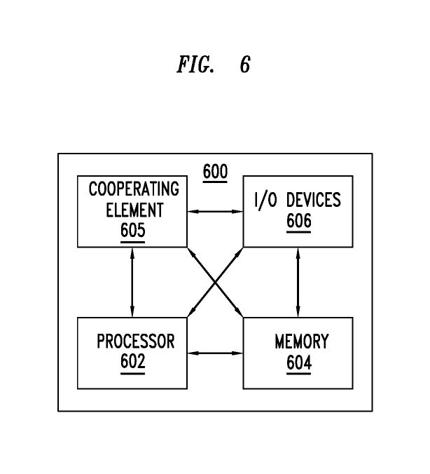

FIG. 6 depicts a high-level block diagram of a computer suitable for use in performing various functions described herein.

The computer 600 includes a processor 602 (e.g., a central processing unit (CPU), a processor having a set of processor cores, a processor core of a processor, or the like) and a memory 604 (e.g., a random access memory (RAM), a read only memory (ROM), or the like). The processor 602 and the memory 604 are communicatively connected.

The computer 600 also may include a cooperating element 605. The cooperating element 605 may be a hardware device. The cooperating element 605 may be a process or set of instructions that can be loaded into the memory 604 and executed by the processor 602 to implement functions as discussed herein (in which case, for example, the cooperating element 605 (including associated data structures) can be stored on a non-transitory computer-readable storage medium, such as a storage device or other storage element (e.g., a magnetic drive, an optical drive, or the like)).

The computer 600 also may include one or more input/output devices 606. The input/output devices 606 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 600 of FIG. 6 may represent a general architecture and functionality suitable for implementing functional elements described herein, portions of functional elements described herein, or the like, as well as various combinations thereof. For example, computer 500 may provide a general architecture and functionality that is suitable for implementing a WED 110, a WAD 121, a scheduler 126, a scheduler 200, an element or elements of wireless system 400, an element or elements of wireless system 500, or the like.

It will be appreciated that the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
separate, for a bearer including a set of application flows, packets of the respective application flows into a respective set of per-flow queues associated with the respective application flows of the bearer;
identify, based on the per-flow queues associated with the respective application flows of the bearer, respective application types of the respective application flows of the bearer;
adapt scheduling of one of the application flows of the bearer based on one or more of the respective application types of one or more of the respective application flows of the bearer; and
adapt scheduling of the bearer based on one or more of the respective application types of one or more of the respective application flows of the bearer.

2. The apparatus of claim 1, wherein the processor is configured to separate the packets of the respective application flows into the per-flow queues based on tuples of the packets.

3. The apparatus of claim 2, wherein the tuples are 5-tuples or 6-tuples.

4. The apparatus of claim 1, wherein, to identify the respective application types of the application flows of the bearer, the processor is configured to:
receive per-flow status information associated with queuing of the packets of the application flows using the per-flow queues associated with the respective application flows of the bearer; and
identify, based on the per-flow status information, the respective application types of the respective application flows of the bearer.

5. The apparatus of claim 4, wherein the per-flow status information comprises at least one of packet arrival pattern information associated with arrival of the packets of the respective application flows of the bearer or queue occupancy information of the per-flow queues associated with the respective application flows of the bearer.

6. The apparatus of claim 4, wherein, to identify the respective application types of the application flows of the bearer, the processor is configured to:
receive status information associated with a wireless access device serving the bearer; and
identify, based on the status information associated with the wireless access device serving the bearer, the respective application types of the respective application flows of the bearer.

7. The apparatus of claim 6, wherein the status information associated with the wireless access device serving the bearer comprises at least one of a cell congestion level or a channel condition experienced by a wireless device served by the wireless access device.

8. The apparatus of claim 1, wherein, to adapt scheduling of the one of the application flows of the bearer, the processor is configured to:
initiate adjustment of a scheduling weight for the one of the application flows of the bearer.

9. The apparatus of claim 1, wherein, to adapt scheduling of the bearer, the processor is configured to:
control selection of the bearer for scheduling within a scheduling interval.

10. The apparatus of claim 1, wherein, to adapt scheduling of the bearer, the processor is configured to:
control assignment of physical resources to the bearer within a scheduling interval.

11. A method, comprising:
separating, by a processor for a bearer including a set of application flows, packets of the respective application flows into a respective set of per-flow queues associated with the respective application flows of the bearer;
identifying, by the processor based on the per-flow queues associated with the respective application flows of the bearer, respective application types of the respective application flows of the bearer;
adapting, by the processor, scheduling of one of the application flows of the bearer based on one or more of the respective application types of one or more of the respective application flows of the bearer; and
adapting, by the processor, scheduling of the bearer based on one or more of the respective application types of one or more of the respective application flows of the bearer.

12. The method of claim 11, wherein the packets of the respective application flows are separated into the per-flow queues based on tuples of the packets.

13. The method of claim 12, wherein the tuples are 5-tuples or 6-tuples.

14. The method of claim 11, wherein identifying the respective application types of the application flows of the bearer comprises:
receiving, by the processor, per-flow status information associated with queuing of the packets of the application flows using the per-flow queues associated with the respective application flows of the bearer; and
identifying, by the processor, based on the per-flow status information, the respective application types of the respective application flows of the bearer.

15. The method of claim 14, wherein the per-flow status information comprises at least one of packet arrival pattern information associated with arrival of the packets of the respective application flows of the bearer or queue occupancy information of the per-flow queues associated with the respective application flows of the bearer.

16. The method of claim 14, wherein identifying the respective application types of the application flows of the bearer comprises:
receiving, by the processor, status information associated with a wireless access device serving the bearer; and
identifying, by the processor based on the status information associated with the wireless access device serving the bearer, the respective application types of the respective application flows of the bearer.

17. The method of claim 16, wherein the status information associated with the wireless access device serving the bearer comprises at least one of a cell congestion level or a channel condition experienced by a wireless device served by the wireless access device.

18. The method of claim 11, wherein adapting scheduling of the one of the application flows of the bearer comprises:
initiating, by the processor, adjustment of a scheduling weight for the one of the application flows of the bearer.

19. The method of claim 11, wherein adapting scheduling of the bearer comprises:
controlling, by the processor, selection of the bearer for scheduling within a scheduling interval.

20. The method of claim 11, wherein adapting scheduling of the bearer comprises:
controlling, by the processor, assignment of physical resources to the bearer within a scheduling interval.

21. An apparatus, comprising:
a processor and a memory communicatively connected to the processor, the processor configured to:
identify, for a set of application flows of a set of bearers, respective application types of the respective application flows, wherein the set of bearers includes a first bearer supporting a first application flow and a second bearer supporting a second application flow and a third application flow;
adapt scheduling of one of the application flows based on one or more of the respective application types of one or more of the respective application flows of the set of bearers; and
adapt scheduling of the set of bearers with respect to each other based on one or more of the respective application types of one or more of the respective application flows of the set of bearers.
